(19) United States
(12) Patent Application Publication
(10) Pub. No.: US 2009/0257922 A1
(43) Pub. Date: Oct. 15, 2009

(54) Penetratable Septum Cap

(76) Inventor: Tony Baker, Sonora, CA (US)

Correspondence Address: King & Spalding LLP, 401 Congress Avenue, Suite 3200, Austin, TX, 78701, US

(21) Appl. No.: 12/424,024

(22) Filed: Apr. 15, 2009

Related U.S. Application Data
(63) Continuation of application No. PCT/US2007/082695, filed on Oct. 26, 2007.
(60) Provisional application No. 60/863,285, filed on Oct. 27, 2006.

(51) Int. Cl. B01L 3/14; B65D 47/36

(52) U.S. Cl. 422/102; 215/247

(57) ABSTRACT

The present disclosure relates to a septum, e.g., for a sample container. A septum may comprise a first layer comprising a sheet of rubberized silicone compound and a second layer comprising a sheet of polytetrafluoroethylene. A second layer may be bonded to a first layer. The present disclosure also relates, in some embodiments, to a septum assembly. A septum assembly may comprise, for example, a septum and a cap. A cap may have an aperture (e.g., to permit insertion and/removal of a sampling device) A septum may be fitted into a cap such that the second layer is adjacent to the aperture. In some embodiments, the present disclosure further relates to a storage assembly. A storage assembly may comprise, for example, a septum assembly and vessel configured and arranged to contain a sample therein. A vessel may be capped by the septum assembly.

### CROSS-REFERENCE TO RELATED APPLICATIONS

This application claims the benefit of U.S. Provisional Application Ser. No. 60/863,285, filed Oct. 27, 2006,entitled “Penetratable Septum Cap.” The entire contents of the aforementioned application is incorporated herein by reference.

### BACKGROUND OF THE INVENTION

With the expanded use of manual and robotic platforms for processing molecular specimens such as specimens including nucleic acids (e.g., DNA or RNA) and/or proteins, two main problems have emerged: specimen contamination and cross-contamination between samples. Existing rubber or rubber matrix septa may pull the tip of a manual or robotic device and/or may not support sampling multiple times.

The problems with specimen contamination and sample cross-contamination are particularly severe when considering the extreme sensitivity of many current analytical techniques, such as Polymerase Chain Reaction (PCR) and Reverse Transcription PCR (RT-PCR). These techniques may be extremely sensitive, so that only a few molecules of DNA or RNA may be amplified into a quantity of DNA large enough to detect via hybridization. For example, a genetic disorder may be detected using the DNA present in one cell, which would carry only two copies of a single gene. However, this high degree of sensitivity also means that any contaminants in a sample that is to be analyzed subsequently by a technique such as PCR or RT-PCR may be amplified and/or subject to analysis. Such contamination may lead to calamitous errors including, in some cases, life-threatening consequences.

### SUMMARY

Therefore, there is a need for a septum cap that reduces and/or prevents such specimen contamination or cross-contamination of samples. In addition, there is a need for an improved septum cap that may be used with manual and/or robotic platforms for processing molecular specimens (e.g., specimens comprising DNA, RNA, and/or proteins). There is also a need for an improved septum cap that may be used as part of a completely closed system to prevent specimen contamination during storage. There is further a need for a septum cap that may be used with a disposable sampling tip to prevent cross-contamination between samples. Furthermore, there is a need for a septum cap that may be sampled multiple times without breaking the seal or damaging the manual or robotic sampling device that is part of the platform.

The present disclosure relates to a septum for sealing a sample (e.g., in a sample container). For example, a septum may comprise:
(a) a first layer comprising a sheet of rubberized silicone compound; and
(b) a second layer comprising a sheet of polytetrafluoroethylene. The second layer may be bonded to the first layer in some embodiments. A septum may be configured and arranged to be pressure fitted into a cap. For example, a septum may be pressure fitted in a cap having an aperture therein for sample insertion and/or removal. According to some embodiments, a septum (e.g., a pressure-fitted septum) may be configured and arranged such that the second layer is adjacent to an aperture of a cap.

At least a portion of the rubberized silicone compound layer, in some embodiments, may be from about 0.01 inches to about 0.1 inches thick (e.g., about 0.056±0.004 inches thick). According to some embodiments, a rubberized silicone compound layer may have a substantially uniform thickness. A rubberized silicone compound layer may comprise, in some embodiments, a rubber selected from a natural rubber, a synthetic rubber, and combinations thereof.

At least a portion of the polytetrafluoroethylene layer, in some embodiments, may be from about 0.001 inches to about 0.01 inches thick (e.g., about 0.004±0.001 inches thick). According to some embodiments, a polytetrafluoroethylene layer may have a substantially uniform thickness.

A rubberized silicone compound layer may be bonded to a polytetrafluoroethylene layer by a bond selected from a heat bond and an adhesive bond, in some embodiments. An adhesive may comprise, in some embodiments, a polyvinyl alcohol adhesive, a silicone adhesive, and combinations thereof.

In some embodiments, a septum may be configured and arranged to have any desired shape including, for example, a shape selected from a circle, an oval, an ellipse, square, and combinations thereof. A septum shape may be, for example, a circle and the diameter of the circle may be from about 0.4 inches to about 0.7 inches (e.g., from about 0.48 inches to about 0.6 inches). A septum, according to some embodiments, may be configured and arranged to fit into a cap selected from a polypropylene cap and a metal cap. A septum, according to some embodiments, may further comprise a dome configured and arranged to permit insertion and/or removal of a sampling device.

The present disclosure also relates to a septum assembly, in some embodiments. For example, a septum assembly may comprise a septum and a cap having an aperture therein for sample insertion and/or removal, wherein the septum is pressure fitted into the cap such that the second layer is adjacent to the aperture. A septum in a septum assembly may comprise, for example, a first layer comprising a sheet of rubberized silicone compound and a second layer comprising a sheet of polytetrafluoroethylene, wherein the second layer is bonded to the first layer.

The present disclosure further relates to a septum storage system, in some embodiments. For example, a storage system may comprise a septum assembly and a vessel configured and arranged to contain a liquid therein and capped by the septum assembly. A septum in a septum assembly may comprise, for example, a septum and a cap having an aperture therein for sample insertion and/or removal, wherein the septum is pressure fitted into the cap such that the second layer is adjacent to the aperture.

A vessel may have any desirable shape including, for example, a cylindrical shape, a tube shape, a conical shape, and/or a cup shape (e.g., a urine cup). A vessel may have one or more protrusions on the bottom thereof according to some embodiments. A vessel may comprise, in some embodiments, a plastic, for example, a plastic selected from polypropylene, polystyrene, polyethylene, and combinations thereof. In some embodiments, a vessel may comprise glass. A vessel may have an interior surface configured and arranged to contact a sample. An interior vessel surface may comprise a coating in some embodiments. A coating may be selected, for example, from a silane coating and a silicone coating.

### BRIEF DESCRIPTION OF THE DRAWINGS

Some embodiments of the disclosure may be understood by referring, in part, to the present disclosure and the accompanying drawings, wherein:

FIG. 1 shows a side view of a septum according to a specific example embodiment of the present disclosure;

FIG. 2 shows a side view of a septum according to a specific example embodiment of the present disclosure forming a dome as it would if inserted into a cap (not shown);

FIG. 3 shows a top view of a septum assembly according to a specific example embodiment of the present disclosure;

FIG. 4 shows a partially cut away side view of a septum assembly according to a specific example embodiment of the present disclosure; and

FIG. 5 shows a top perspective view of a storage system according to a specific example embodiment of the present disclosure.

### DETAILED DESCRIPTION OF THE INVENTION

A septum for sealing a sample may provide a positive closure and/or may protect a sample from contamination. The septum is particularly suitable for use with disposable tips or other sampling devices, thus preventing cross-contamination. A septum according to some embodiments of the present disclosure may comprise: (1) a first layer comprising a sheet of rubberized silicone compound; and (2) a second layer comprising a sheet of polytetrafluoroethylene bonded to the first layer to form a septum; wherein the septum is configured to be pressure fitted into a cap having an aperture therein for sample insertion and/or removal such that the second layer is adjacent to the aperture. Some embodiments of the disclosure may include a septum assembly comprising a septum fitted into a cap and a storage system for storage of a liquid sample comprising the septum assembly and a storage vessel for storage of a liquid sample therein, the storage vessel being capped by the septum assembly.

The present disclosure relates to a septum for sealing a sample (e.g., in a sample container). For example, according to some embodiments of the disclosure, a septum may comprise:
(1) a first layer comprising a sheet of rubberized silicone compound; and
(2) a second layer comprising a sheet of polytetrafluoroethylene bonded to the first layer to form a septum, wherein the septum is configured to be pressure fitted into a cap having an aperture therein for sample insertion and/or removal such that the second layer is adjacent to the aperture. Samples may contain DNA, RNA, protein, and/or other analytes such as drugs (e.g., therapeutic drugs and/or abused drugs).

At least a portion of a rubberized silicone compound layer may be about 0.056±0.008 inches thick. For example, at least a portion of a rubberized silicone compound layer may be about 0.056±0.004 inches thick. A rubberized silicone compound layer may comprise natural rubber and/or synthetic rubber. At least a portion of a polytetrafluoroethylene layer may be about 0.004±0.002 inches thick. For example, at least a portion of a polytetrafluoroethylene layer may be about 0.004±0.001 inches thick.

One of ordinary skill in the art having the benefit of the instant disclosure will recognize that the likelihood of tip-fouling and/or binding may increase as the thickness of a layer increases. One of ordinary skill in the art having the benefit of the instant disclosure will also recognize that the capacity to reseal may decrease as the thickness of a layer decreases.

In some embodiments, a rubberized silicone compound layer may be bonded to a polytetrafluoroethylene layer by heat bonding and/or by an adhesive. An adhesive may be selected from polyvinyl alcohol adhesives and/or silicone adhesives.

A septum may be circular in shape according to some embodiments. A circular septum may have a diameter of about 0.6 inches (e.g., about 0.48 inches). In some embodiments, a septum may be configured to fit into a cap and/or a metal cap (e.g., a polypropylene cap and/or a metal cap).

In some embodiments, a septum may allow tip penetration with little or no binding. Reduced binding may be assessed, for example, in terms of the rate of binding or pulling the tip off a robotic or pipetting device. A septum according to some embodiments of the disclosure may allow for repeated tip penetration and resealing. A septum may reseal (e.g., up to about six times) without failing to seal and protect the sample.

A septum, in some embodiments, may be pressure fitted into a cap in a way that pushes up (e.g., slightly pushes up) a polytetrafluoroethylene layer, creating a dome. In some embodiments, a septum may be dome-shaped in the absence of an attached tube (e.g., at atmospheric pressure). A septum may form a dome, in some embodiments, under the influence of positive pressure (e.g., when attached to a tube, the tube having positive pressure). Where positive pressure exists, a sampling device may be configured and arranged to minimize release of that pressure and/or restore pressure (e.g., by inserting nitrogen, air, or another gas). A septum dome may be configured and arranged, in some embodiments, to protrude from a storage system (e.g., a tube) A dome may be slight (e.g., nearly flat) or more pronounced (e.g., hemispherical) in some embodiments. The distance between the dome apex and the plane of a vessel aperture may be from about 1% to about 60% (e.g., about 1% to about 50%, about 2% to about 30%, about 5% to about 25%) of the diameter of the vessel aperture.

Without limiting any embodiment to any particular mechanism of action, this dome may allow the tip of a pipette or other sampling device to penetrate easily and/or may allow the septum to reseal easily upon pipette removal. In some embodiments, a domed septum may be penetrated by a pipette with fewer binding and/or fouling events than a septum without a dome (e.g., a flat septum). A domed septum may be penetrated, in some embodiments, by a pipette with fewer binding and/or fouling events than a vacuum tube septum (e.g., convex or bowl-shaped). In some embodiments, a domed septum may effectively reseal after more pipette penetrations than a septum without a dome (e.g., a flat septum). A domed septum may effectively reseal, in some embodiments, after more pipette penetrations than a vacuum tube septum (e.g., convex or bowl-shaped). Formation of a dome, according to some embodiments, may be facilitated by having a polytetrafluoroethylene layer adjacent to the aperture for sample insertion and/or removal. In some embodiments, formation of a dome, may be facilitated by pressure fitting a septum such that it is locked into a cap.

According to some embodiments, a septum may be configured and arranged to have a Shore A Durometer (Rockwell Hardness Test) of from about 25 to about 65 durometers, from about 30 to about 60 durometers, from about 35 to about 55 durometers, and/or from about 40 to about 50 durometers.

The present disclosure also relates to a septum assembly. In some embodiments, a septum assembly may comprise:
(1) a septum; and
(2) a cap into which the septum is pressure fitted. The cap of the septum assembly may comprise polypropylene and/or metal.

In addition, the present disclosure relates to a liquid sample storage system which may comprise:
(1) a septum assembly; and
(2) a vessel for containing and/or storing a liquid sample therein, the vessel being capped by the septum assembly.

A vessel (e.g., a storage vessel) may be cylindrical or partially conical with a cylindrical portion. A storage vessel may have one or more protrusions on the bottom thereof to facilitate storage, handling, or racking. A storage vessel may be constructed of a plastic, such as polypropylene, polystyrene, and/or polyethylene. A storage vessel may be constructed of glass. In some embodiments, a storage vessel may be coated on the inside to prevent adherence of protein in a protein-containing liquid sample to the storage vessel. A coating may comprise a silicone coating.

The present disclosure relates to a septum that, according to some embodiments, may address one or more of the problems described herein. In some embodiments, a septum may be used with manual and/or robotic samplers as part of a manual and/or robotic sampling platform. A septum of the present disclosure may form a closed system (e.g., a totally closed system) that protects a sample held in a vessel being sealed by the septum from contamination. A septum also may allow multiple samples to be removed from a specimen and/or storage vessel. Disposable sampling tips may be used to prevent cross-contamination.

A septum, in some embodiments, may comprise a plurality of layers. For example, a septum may comprise 2, 3 or 4 layers. A first layer may comprise a sheet (e.g., a sheet of uniform and/or non-uniform thickness) comprising a silicone rubber compound. In some embodiments, a first layer may comprise a two or more sheets. A second layer may comprise a sheet (e.g., a sheet of uniform and/or non-uniform thickness) comprising polytetrafluoroethylene. A second layer, in some embodiments, may comprise two or more sheets. A first layer may be adjacent to (e.g., bonded to) a second layer. A second layer may be configured and arranged (e.g., during or after manufacture) to fit in a cap having an aperture. A septum having a second layer may be configured and arranged in a cap such that the second layer is adjacent to the aperture. Third, fourth, and/or further layers may be the same or different from the first and/or second layers.

A septum may be configured and arranged in any curvilinear shape. For example, a septum shape may be selected from a circle, an oval, and/or an ellipse. A septum may be configured and arranged to be pressure fitted into a cap. A septum may be, for example, circular and may be pressure fitted into a (circular) cap. In some embodiments, the longest dimension of a septum may be from about 0.4 inches to about 0.7 inches. For example, the diameter of the septum may be about 0.48 inches or about 0.6 inches.

In some embodiments, a first layer (e.g., comprising rubberized silicone compound) may be from about 0.01 inches to about 0.1 inches and/or from about 0.04 inches to about 0.7 inches (e.g., 0.056±0.008) thick). A septum (e.g., a rubberized silicon compound layer) may comprise natural rubber and/or synthetic rubber. A second layer (e.g., comprising polytetrafluoroethylene) may be from about 0.001 inches to about 0.01 inches and/or from about 0.001 inches to about 0.005 inches (e.g., 0.004±0.002 inches) thick.

A cap into which a septum may be fitted may comprise metal and/or polypropylene, and the septum is configured appropriately. Metal vial caps for pharmaceuticals known in the art may be fitted with a septum according to some embodiments of the disclosure.

A rubberized silicone compound layer may be bonded to a polytetrafluoroethylene layer by heat bonding and/or by an adhesive. An adhesive may be selected from a polyvinyl alcohol adhesive, a silicone adhesive, and combinations thereof. An adhesive may maintain its adhesive qualities throughout a temperature range of from about −80° C. to about 40° C.

In some embodiments, a septum may be configured and arranged to permit insertion and removal of an instrument (e.g., a sampling instrument). For example, a septum may permit the tip of a robotic or pipetting device to be inserted through the septum into a sample vessel and removed without binding or removing the tip from the robotic or pipetting device. A septum, in some embodiments, may reseal (e.g., completely reseal) up to about six times to contain and protect the sample.

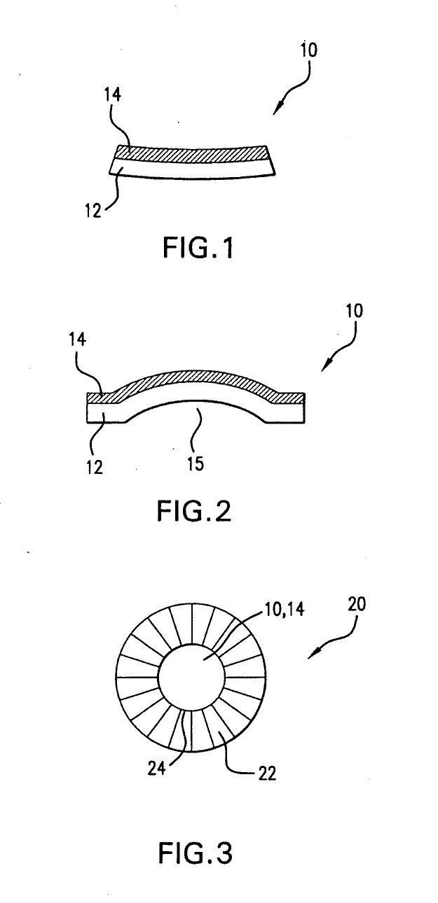

A specific example embodiment of a septum is shown in side view in FIG. 1. In FIG. 1, septum 10 has a first layer 12 and a second layer 14. First layer 12 is shown at the bottom of septum 10 and would be located further than second layer 14 from an aperture in a cap when septum 10 is placed in a cap (not shown in FIG. 1).

FIG. 2 shows septum 10 forming a dome as it would if inserted into cap 22. In FIG. 2, septum 10 includes first layer 12 and second layer 14. In FIG. 2, dome 15 is shown as formed by the change in position of first layer 12 and second layer 14 when inserted into cap 22.

According to some embodiments, a septum assembly may comprise:
(1) a septum; and
(2) a cap wherein the septum is pressure fitted into the cap. A cap may be a plastic cap, such as a polyethylene cap. A cap may have aperture therein for sample insertion and/or removal.

A top view of a septum assembly according to a specific example embodiment of the disclosure is shown in FIG. 3. In FIG. 3 septum assembly 20 includes septum 10 and cap 22. Septum 10 includes a first layer (not shown in FIG. 3) and a second layer 14. Cap 22 includes an aperture 24 for sample insertion and/or removal; second layer 14 of septum 10 is visible through aperture 24.

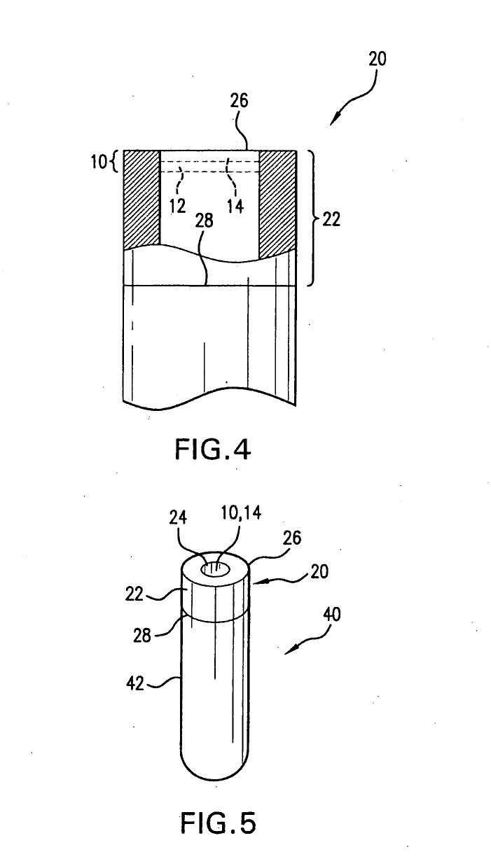

A partially cut away side view of a specific example embodiment of a septum assembly is shown in FIG. 4. In FIG. 4 septum assembly 20 includes septum 10 and cap 22. Cap 22 includes a first surface 26 and a second surface 28; first surface 26 of cap 22 includes an aperture for insertion and/or removal of a sample (not shown in this view). Septum 10, shown in cutaway view, includes first layer 12 and second layer 14, with second layer 14 being located adjacent to the first surface 26 of cap 22.

A liquid sample storage system, in some embodiments, may comprise a septum assembly and a storage vessel configured and arranged to contain and/or share a liquid (e.g., a liquid sample), wherein the storage vessel is capped by the septum assembly.

A storage vessel may have any regular or irregular geometric shape. For example, a storage vessel may be well or tube shaped, e.g., cylindrical or partially conical with a cylindrical portion. A storage vessel may have a rounded bottom and/or may have one or more protrusions on the bottom to facilitate storage, handling, and/or racking. A storage vessel may be constructed of a suitable plastic such as polypropylene, polystyrene, and/or polyethylene. A storage vessel may comprise glass. A storage vessel may be coated on the inside to reduce and/or prevent adherence of a sample material (e.g., protein in a protein-containing liquid sample) to the storage vessel. A coating may comprise a silicone coating. This is particularly useful when the storage vessel is glass. In some embodiments, glass may be silanized to reduce and/or prevent adherence of a sample material.

A top perspective view of a specific example embodiment of a storage system is shown in FIG. 5. Storage system 40 includes septum assembly 20, including cap 22 and second layer 14 of septum 10, as well as storage vessel 42. First surface 26 of cap 22 includes aperture 24 for sample insertion and/or removal; second layer 14 of septum 10 is visible through the aperture. Cap 22 has a second surface 28 opposite to first surface 26. Second surface 28 of cap 22 forms a seal with storage vessel 42. Storage vessel 42 may be of any suitable shape or material.

The present disclosure provides an improved septum for use with manual and/or automated sampling devices. A septum, according to some embodiments, may provide a tight seal reducing and/or preventing contamination of a sample being stored in a sample vial sealed with the septum. A septum may be used effectively with disposable sampling tips and may prevent cross-contamination when so used.

Septa, septum assemblies, and/or liquid sample storage systems according to some embodiments of the present disclosure may possess industrial applicability for sample storage and handling, for example, in the context of use with automated or manual sampling devices. Samples to be stored and handled may include DNA samples, RNA samples, protein samples, and/or samples containing other analytes.

As will be understood by those skilled in the art who have the benefit of the instant disclosure, other equivalent or alternative devices, methods, and systems for sealing a vessel while permitting multiple insertions and resealings can be envisioned without departing from the description contained herein. Accordingly, the manner of carrying out the disclosure as shown and described is to be construed as illustrative only.

Persons skilled in the art may make various changes in the shape, size, number, and/or arrangement of parts without departing from the scope of the instant disclosure. For example, a storage system may be configured and arranged to contain from less than a microliter to over several liters. A septum assembly may serve as a sample port and need not seal the only opening in a vessel. For example, a large container may include a larger diameter opening for inserting and/or removing larger volumes in addition to a septum assembly for inserting and/or removing smaller volumes. In addition, the size of a septum may be scaled up or down to suit the needs and/or desires of a practitioner. Also, where ranges have been provided, the disclosed endpoints may be treated as exact and/or approximations as desired or demanded by the particular embodiment. In addition, it may be desirable in some embodiments to mix and match range endpoints. A septum, septum assembly, and/or a storage system may be configured and arranged to be disposable, serviceable, interchangeable, and/or replaceable. Although examples of a septum resealing have been provided in terms of sampling devices (e.g., pipettes), it is not necessary to actually remove sample in all embodiments. For example, material may be inserted through a pipette or the instrument inserted into the septum may be solid. These equivalents and alternatives along with obvious changes and modifications are intended to be included within the scope of the present disclosure. Accordingly, the foregoing disclosure is intended to be illustrative, but not limiting, of the scope of the disclosure as illustrated by the following claims.

### EXAMPLE

Some embodiments of the disclosure may be illustrated by the following Example.

### Penetratable Septum Construction

### Example 1

### Materials Specification

1. Shore A Durometer (Rockwell Hardness Test) 45±5 durometers.
2. Silicone/rubber compound bonded to PTFE (Teflon®).
3. Colors: PTFE, natural; silicone rubber, white.
4. PTFE Thickness: 0.004±0.001 inch.
5. Total Thickness: 0.060±0.005 inch.

### Example 2

### Penetration Data Summary for Penetratable Septum

The data described herein were obtained with the Qiagen Biorobot 3000 Molecular Workstation (X-Y Robot), an automated sampler.

Test 1: Septum Design 1 (Teflon® side up): 200 septa, 200 penetrations with 100-μL tips, with a single penetration per septum. There were no failures.

Test 2: Septum Design 2 (Teflon® side down): 200 septa, 200 penetrations with 100-μL tips, with a single penetration per septum. There were 194 failures.

Test 3: Septum Design 1 (Teflon® side up): 200 septa, 200 penetrations with 200-μL tips, with a single penetration per septum. There were 2 failures.

Test 4: Septum Design 2 (Teflon® side down): 200 septa, 200 penetrations with 200-μL tips, with a single penetration per septum. There were 200 failures.

In Tests 1-4, failure was determined by the pipetting tip being completely pulled off or by tip binding in septum jamming the robot and requiring complete manual reset of the robot.

The results of Tests 1-4 show that a septum according to the present invention, with the Teflon® side located so that the sampling device first penetrates the Teflon® layer, is virtually failure free when used for sampling with an automated robotic sampling device.

### Example 3

### Resealing Data Summary for Penetratable Septum

A 15 mL tube was filled with 4 mL of a carbonated solution (a soft drink) containing a colored dye and sealed with a domed septum according to Example 1. A 100 μL PCR pipette tip was manually inserted and removed from the septum seven (7) times. The tube was then vigorously shaken and observed for the appearance of any of the dyed solution on the septum. A total of 5 replicas were performed. The dyed solution was not observed on any of these tubes.

1. A septum comprising:
(a) a first layer comprising a sheet of rubberized silicone compound; and
(b) a second layer comprising a sheet of polytetrafluoroethylene, wherein the second layer is bonded to the first layer and wherein the septum is configured and arranged to be pressure fitted into a cap having an aperture therein for sample insertion and/or removal such that the second layer is adjacent to the aperture.

2. A septum according to claim 1, wherein at least a portion of the rubberized silicone compound layer is from about 0.01 inches to about 0.1 inches thick.

3. A septum according to claim 2, wherein the at least a portion of the rubberized silicone compound layer is about 0.056±0.004 inches thick.

4. A septum according to claim 1, wherein (a) the rubberized silicone compound layer has a substantially uniform thickness, (b) the polytetrafluoroethylene layer has a substantially uniform thickness, or (c) the rubberized silicone compound layer has a substantially uniform thickness and the polytetrafluoroethylene layer has a substantially uniform thickness.

5. A septum according to claim 1, wherein the rubber silicone compound comprises a rubber selected from the group consisting of a natural rubber, a synthetic rubber, and combinations thereof.

6. A septum according to claim 1, wherein at least a portion of the polytetrafluoroethylene layer is from about 0.001 inches to about 0.01 inches thick.

7. A septum according to claim 6, wherein the at least a portion of the polytetrafluoroethylene layer is about 0.004±0.001 inches thick.

8. (canceled)

9. A septum according to claim 1, wherein the rubberized silicone compound layer is bonded to the polytetrafluoroethylene layer by a bond selected from a heat bond and an adhesive bond.

10. A septum according to claim 9, wherein the bond is an adhesive and the adhesive is selected from the group consisting of a polyvinyl alcohol adhesive, a silicone adhesive, and combinations thereof.

11. A septum according to claim 1, wherein the septum has a shape selected from the group consisting of a circle, an oval, an ellipse, and combinations thereof.

12. A septum according to claim 11, wherein the septum shape is a circle and the diameter of the circle is from about 0.4 inches to about 0.7 inches.

13. A septum according to claim 12, wherein the diameter of the circle is from about 0.48 inches to about 0.6 inches.

14. A septum according to claim 1, wherein the septum is configured and arranged to fit into a cap selected from a polypropylene cap and a metal cap.

15. A septum according to claim 1, wherein the septum further comprises a dome configured and arranged to permit insertion and removal of a sampling device.

16. A septum assembly comprising:
(a) a septum comprising:
(i) a first layer comprising a sheet of rubberized silicone compound; and
(ii) a second layer comprising a sheet of polytetrafluoroethylene, wherein the second layer is bonded to the first layer; and
(b) a cap having an aperture therein for sample insertion and/or removal, wherein the septum is pressure fitted into the cap such that the second layer is adjacent to the aperture.

17. A storage system comprising:
(a) a septum assembly comprising:
(i) a septum comprising:
a first layer comprising a sheet of rubberized silicone compound; and
a second layer comprising a sheet of polytetrafluoroethylene, wherein the second layer is bonded to the first layer, and
(ii) a cap having an aperture therein for sample insertion and/or removal,
wherein the septum is pressure fitted into the cap such that the second layer is adjacent to the aperture; and
(b) a vessel configured and arranged to contain a sample therein and capped by the septum assembly.

18. A storage system according to claim 17, wherein the vessel is configured and arranged to contain a sample comprising a liquid.

19. A storage system according to claim 17, wherein the vessel has shape selected from the group consisting of a cylinder and a tube.

20. A storage system according to claim 17, wherein the vessel has one or more protrusions on the bottom thereof.

21. A storage system according to claim 17, wherein the vessel comprises glass or a plastic.

22. A storage system according to claim 21, wherein the plastic is selected from the group consisting of polypropylene, polystyrene, and polyethylene.

23. (canceled)

24. A storage system according to claim 17, wherein the vessel has an interior surface comprising a coating.

25. A storage system according to claim 24, wherein the coating comprises a material selected from the group consisting of a silane coating and a silicone coating.
